(19) United States
(12) Patent Application Publication
(10) Pub. No.: US 2013/0070360 A1
(43) Pub. Date: Mar. 21, 2013

(54) PORTABLE MEDIA PLAYER DEVICE

(71) Applicant: PRADEEP RAMDEO, Bronx, NY (US)

(72) Inventor: PRADEEP RAMDEO, Bronx, NY (US)

(21) Appl. No.: 13/234,231

(22) Filed: Sep. 16, 2011

(51) Int. Cl. G11B 5/02

(52) U.S. Cl. 360/55; G9B/5.026

(57) ABSTRACT

A portable media player device includes a built-in mobile virtual private network and housing. A touch screen is mounted on the housing. A memory unit within the housing stores local and remote movie, video, photo, music and game files. A processing unit within the housing is adapted to execute media file stored in the memory unit and stored in the remote home computer and display the files on the touch screen. A user using the portable media player device can utilize the local and remote files by touching specific keys on the touch screen.

### BACKGROUND OF THE INVENTION

1. Field of the Invention

The present invention relates generally to a mobile media player, and more particularly, a portable media device.

The portable media device is configured to assist a user in managing, viewing, storing, and transporting their favorite movies, videos, photos, music and games in a virtual hard-drive. The present invention affords the user access to their media library at all times without the need of a computer. The user is able to store their entire media collection on the portable media device and is even able to record television shows and movies for playback. The present invention eliminates the need to purchase CDs, DVDs, and other forms of media. The portable media device uses a memory unit to store and save a large variety of media that can be accessed at any time.

2. Description of the Prior Art

Many individuals enjoy watching movies and listening to music. Currently, a user's media collection can only be viewed at home, unless the user wants to transport a large library of CDs and DVDs. These discs tend to consume valuable space in both the home and while traveling. They are also prone to damage can be rendered useless. Some people record television shows or movies using their cable box. However, this media cannot be viewed in a location other than where the cable box is located. A more efficient option is needed.

Numerous innovations for digital interface systems have been provided in the prior art that will be described. Even though these innovations may be suitable for the specific individual purposes to which they address, however, they differ from the present invention.

A FIRST EXAMPLE, U.S. Patent Office Publication No. 2008/0174570, Published on Jul. 24, 2008, to Jobs et al. teaches a computer-implemented method for use in conjunction with a computing device with a touch screen display that comprises detecting one or more finger contacts with the touch screen display, applying one or more heuristics to the one or more finger contacts to determine a command for the device, and processing the command. The one or more heuristics comprise a heuristic for determining that the one or more finger contacts correspond to a one-dimensional vertical screen scrolling command, a heuristic for determining that the one or more finger contacts correspond to a two-dimensional screen translation command, and a heuristic for determining that the one or more finger contacts correspond to a command to transition from displaying a respective item in a set of items to displaying a next item in the set of items.

A SECOND EXAMPLE, U.S. Patent Office Publication No. 2009/0249247, Published on Oct. 1, 2009, to Tseng et al. teaches a computer-implemented user notification method that includes displaying, in a status area near a perimeter of a graphical interface, a notification of a recent alert event for a mobile device, receiving a user selection in the status area, and in response to the receipt of the user selection, displaying, in a central zone of the graphical interface, detail regarding a plurality of recent messaging events for the mobile device.

A THIRD EXAMPLE, U.S. Patent Office Publication No. 2009/0257507, Published on Oct. 15, 2009, to Guo et al. teaches a technique for processing decoded video data to mask visual compression artifacts resulting from video compression. In accordance with this technique, a hardware block is provided for generating and adding random noise to the decoded video stream. In one embodiment, a random number is generated for each pixel of the decoded video data and compared against one or more threshold values to determine a threshold range. In such an embodiment, a noise addend value is selected based upon the threshold comparison and summed with the current pixel. While the present technique may not eliminate the compression artifacts, the addition of random noise renders the compression artifacts less noticeable to the human eye and, therefore, more aesthetically pleasing to a viewer.

A FOURTH EXAMPLE, U.S. Patent Office Publication No. 2010/0160190, Published on Jun. 24, 2010, to Smolinski et al. teaches a method of navigation/manipulation and display of media or data residing on a media player type device or other limited display system. The method includes a non-hierarchical intelligent associative reorganization of the media player database as stored on the media device. The method implements a technique to display the database entries that promotes the application of associative connections by the user to the database entries during the navigation of the database. Therefore, the selection of media objects or data entries that make up a play list as it is generated by the user is constructed using associative connections while the user traverses the non-hierarchical presentation of the database. The present invention also includes a remote control data management system that includes a docking station and a remote control unit that maintains and manipulate metadata in one or more databases even after a media player has been disconnected.

A FIFTH EXAMPLE, U.S. Patent Office Publication No. 2010/0164836, Published on Jul. 1, 2010, to Liberatore teaches a digital photo album which includes, in one embodiment, a digital viewing unit for viewing digital media and a storage location for housing digital media viewable on the digital viewing unit.

A SIXTH EXAMPLE, U.S. Patent Office Publication No. 2010/0321304, Published on Dec. 23, 2010, to Rofougaran teaches a portable device that includes a touch screen that includes a display screen and that generates touch screen data in response to a user's interaction with the touch screen. A processor executes a security application for authenticating the user to the portable device that provides first display data to the touch screen for displaying a security prompt on the display screen. Touch screen data is received from the touch screen in response to the user's interaction with the touch screen and is processed to determine when an authentication shape is recognized as being indicated by the touch screen data. The user is authenticated to the portable device when the authentication shape is recognized as being indicated by the touch screen data.

A SEVENTH EXAMPLE, U.S. Patent Office Publication No. 2011/0053510, Published on Mar. 3, 2011, to Bolton et al. teaches techniques for facilitating interoperation between a portable media device having an RF tuner and an accessory device. In certain embodiments, the portable media device and the accessory can exchange various commands pertaining to the capabilities, state, and/or operation of the tuner. For example, in one set of embodiments the accessory can send one or more commands requesting information about the capabilities of the tuner, and the portable media device can provide the requested capability information. In another set of embodiments, the accessory can send one or more commands requesting execution of a particular action with respect to the tuner, and the portable media device can perform the requested action. In this manner, certain embodiments of the present invention enable a user to control the tuner functionality of the portable media device via the accessory, rather than, e.g., via an input interface located directly on the portable media device.

AN EIGHTH EXAMPLE, U.S. Patent Office Publication No. 2011/0142016, Published on Jun. 16, 2011, to Chatterjee teaches methods, program products, and systems for ad hoc networking based on content and location. A user of a mobile device can identify another user using another mobile device who is close by, if both users have requested to participate in networking. Common interests and experiences of two or more users located close to each other can be identified from content, including automatically created usage data of the mobile devices. Usage data of a mobile device can be created based on activities performed on the mobile device (e.g., songs downloaded), a trajectory of the mobile device (e.g., places traveled), or other public data available from the mobile device (e.g., pictures shared). Each of the users can be notified that another user having the common interests and experiences is close by. A means of initiating communication can be provided to the users to facilitate communication between the users.

A NINTH EXAMPLE, U.S. Patent Office Publication No. 2011/0150414, Published on Jun. 23, 2011, to Garrett et al. teaches a portable media player (PMP) that has non-volatile memory, at least one communication interface to remote digital devices, a touchscreen, and software stored on and executing from a machine-readable physical medium. The software provides functionality to enable a user, via touchscreen controls, with the PMP coupled to a digital video recorder (DVR), to browse indicators of video files stored on the DVR, to select and download files to the non-volatile memory of the PMP, and to play the video files on the touchscreen of the PMP after the PMP is uncoupled from the DVR.

A TENTH EXAMPLE, U.S. Patent Office Publication No. 2011/0164042, Published on Jul. 7, 2011, to Chaudhri teaches a multifunction device having a touch-sensitive surface that displays graphical objects that represent digital content products, each graphic object having a front side image and a back side image. An initial display shows front side images of objects representing digital content products. A user input selects a graphical object, resulting in an animation that simultaneously flips the graphical object over and enlarges it. At the end of the animation, the back side is displayed, and is larger than the initial front side image. A second user input on a front side image of a second graphical object results in a second animation that simultaneously flips the first graphical object over and reduces its size, and also flips the second graphical object over and enlarges it. The front side image of the first graphical object and the back side image of the second graphical object are thereby concurrently displayed.

A ELEVENTH EXAMPLE, U.S. Patent Office Publication No. 2011/0202848, Published on Aug. 18, 2011, to Weatherly et al. teaches systems and methods of providing electronic features for creating a customized media player interface for an electronic device include providing a graphical user interface design area having a plurality of display elements. Electronic input signals then may define for association with selected display elements one or more electronic actions relative to the initiation and control of media files accessible by the electronic device (e.g., playing, pausing, stopping, adjusting play speed, adjusting volume, adjusting current file position, toggling modes such as repeat or shuffle, and/or establishing, viewing and/or clearing a playlist.) Additional electronic input signals may define for association with selected display elements labels such as action identification labels or media status labels. A graphical user interface is then initiated on an electronic display associated with an electronic device, wherein the graphical user interface comprises media player features corresponding to the plurality of display elements and associated electronic actions and/or labels.

A TWELFTH EXAMPLE, U.S. Patent Office Publication No. 2011/0216206, Published on Sep. 8, 2011, to Ashforth et al. teaches a portable electronic device which comprises a display facing in a first direction, a video camera facing in a second direction substantially opposite to the first direction, and a wireless communications receiver operable to receive supplementary image data from a remote image source, the supplementary image data comprising an indication of where a supplementary image is positioned with respect to a reference image. The portable electronic device is arranged in operation to display a captured image from the video camera on the display of the portable electronic device. When the captured image comprises all or part of the reference image as displayed on a separate display associated with the remote image source, the portable electronic device is arranged in operation to display the supplementary image positioned with respect to the reference image, instead of the corresponding part of the captured image.

It is apparent now that numerous innovations for digital interface systems have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a portable media device that avoids the disadvantages of the prior art.

ANOTHER OBJECT of the present invention is to provide a portable media device that is simple and inexpensive to manufacture.

STILL ANOTHER OBJECT of the present invention is to provide a portable media device that is simple to use.

BRIEFLY STATED, STILL YET ANOTHER OBJECT of the present invention is to provide a portable media player device which comprises a housing. A touch screen is mounted on the housing. A memory unit within the housing stores movie, video, photo, music and game files. A processing unit within the housing is adapted to execute any file stored in the memory unit and display the file on the touch screen. A user using the portable media player device can utilize the file by touching specific keys on the touch screen.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view of the present invention per se;

FIG. 2 is a block diagram showing the various components within the present invention;

FIG. 3 is a perspective view showing a user using the present invention while traveling in a motor vehicle;

FIG. 4 is a perspective view similar to FIG. 3, showing a user viewing, playing, or recording their media library;

FIG. 5 is a perspective view similar to FIG. 3, showing a user playing a game; and

FIG. 6 is a perspective view of the present invention.

### REFERENCE NUMERALS UTILIZED IN THE DRAWING

110 portable media device
112 housing of device 110
114 touch screen of device 110
116 memory unit of device 110
118 processing unit of device 110
120 user
122 hard drive of device 110
124 Wi-Fi network of device 110
126 DVD/CD player/burner of device 110
128 USB port of device 110
130 SD port of device 110
132 speaker of device 110
134 camera of device 110
136 wireless receiver of device 110
138 remote control unit of device 110
140 mobile virtual private network (VPN)
150 three keys for playback the media files
160 key for remote recording the TV shows
190 remote or home computer for storing customized media library
200 networked set-of-box
210 remote networked television set
220 local television set

### DETAILED DESCRIPTION OF THE PREFERRED EMBODIMENT

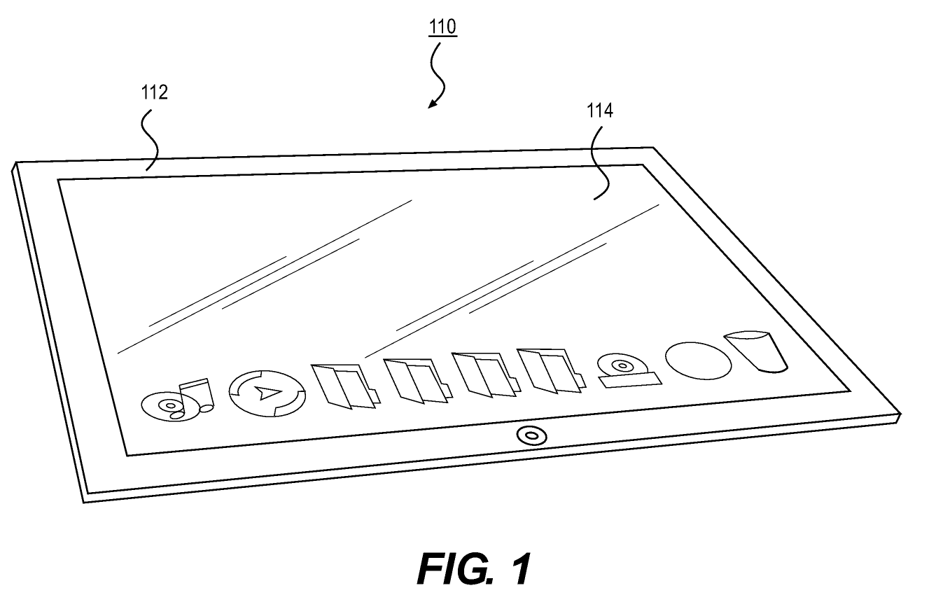

As shown in FIG. 1, is a portable media player device 110 which comprises a housing 112 (in a form of a tablet or a minicomputer). A touch screen 114 (e.g. multi-touch) mounted on the housing 112. A memory unit 116 is located within the housing 112 for storing movie, video, photo, music and game files.

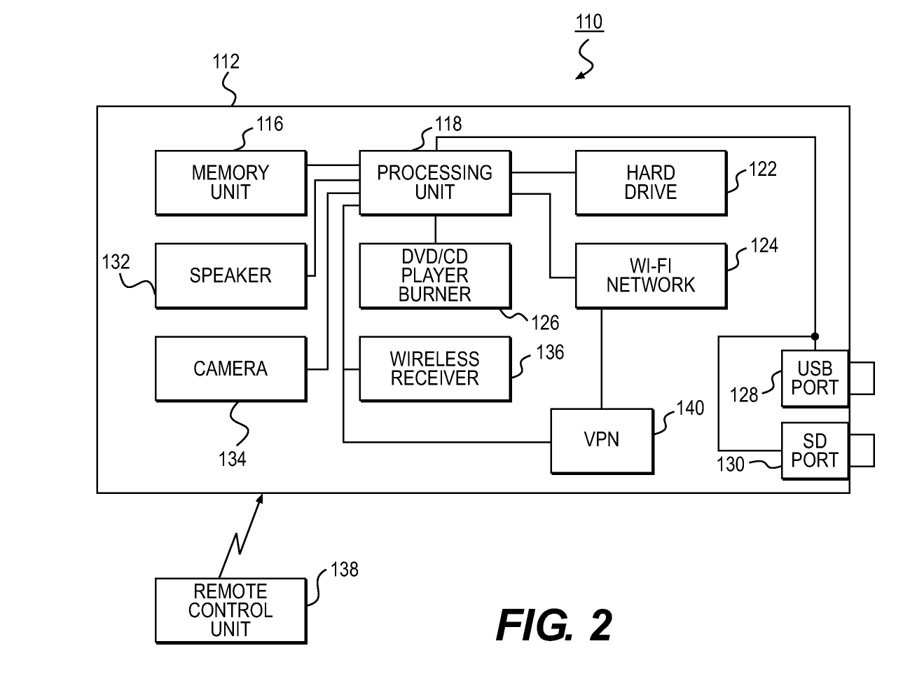

As shown in FIG. 2, a processing unit 118 within the housing 112 is adapted to execute the media files stored in the memory unit 116 and display the files on the touch screen 114. The device 110 further comprises a hard drive 122 within the housing 112. A Wi-Fi network 124, wireless receiver 136 and mobile Virtual Private Network (VPN) 140 within the housing 112 is connected to the processing unit 118 to allow the user 120 to directly download from a remote home computer 190 via the internet the customized movie, video, photo, music and game files. An optional DVD/CD player/burner 126 is within the housing 112, whereby the movie and music files may be loaded onto the hard drive 122. Movies, music, and shows may be purchased from a website or other forum and be downloaded directly to the built-in hard drive 122 using the Wi-Fi network 124, wireless receiver 136 and built-in mobile Virtual Private Network (VPN) 140 in 802.11a/b/g/n standard. The mobile VPN 140 is used for roaming seamlessly across networks and in and out of wireless-coverage areas without losing application sessions or dropping the secure VPN session. A conventional VPN cannot survive such events because the network tunnel is disrupted, causing applications to disconnect, time out, or fail, or even cause the computing device itself to crash. Instead of logically tying the endpoint of the network tunnel to the physical IP address, each tunnel is bound to a permanently associated IP address at the device 110. The mobile VPN software handles the necessary network authentication and maintains the network sessions in a manner transparent to the application and the user. All of the customized media files will be stored in a virtual hard drive. The device 110 also comprises a USB port 128 and a SD port 130 on the housing 112 for additional file storage. At least one speaker 132, a camera 134 and a wireless receiver 136 is in the housing 112. To operate the device 110 is a remote control unit 138 may be used by the user 120.

In review, the portable media device 110 provides a user 120 with an efficient way for organizing and viewing their customized media library. The present invention consists of a housing 112 that may be approximately the size of a tablet computer, although various models could have different sizes and features. The device 110 includes a touch screen 114, which may have swiveling capabilities (e.g. mini-computer or laptop form), HDMI output (e.g. 1080p), as well as High Definition (HD) properties.

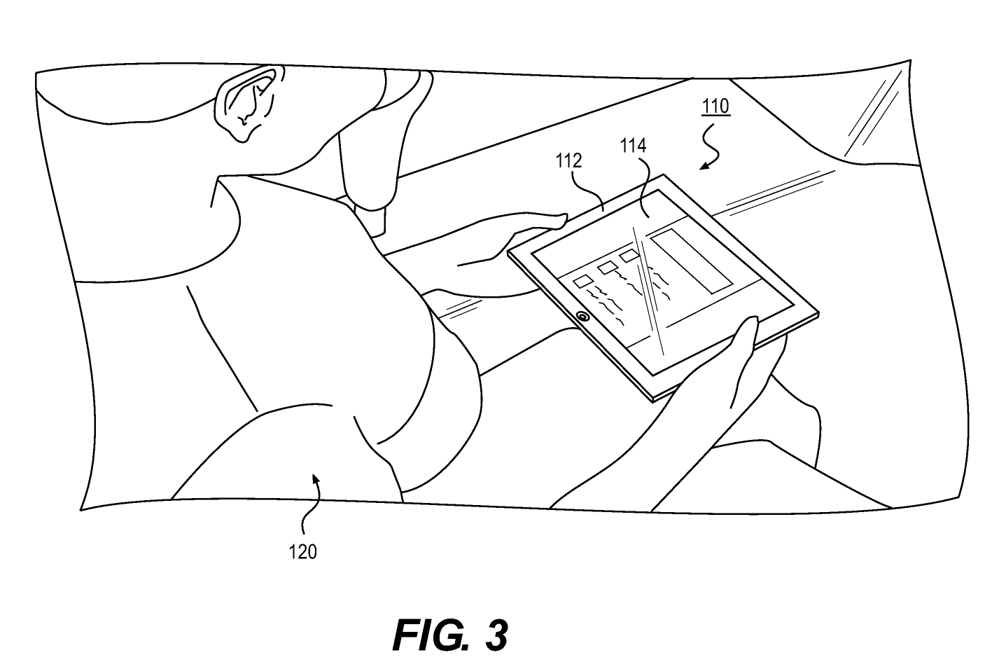

In FIG. 3, a user 120 using the portable media device 110 can utilize the files by touching specific keys on the touch screen 114.

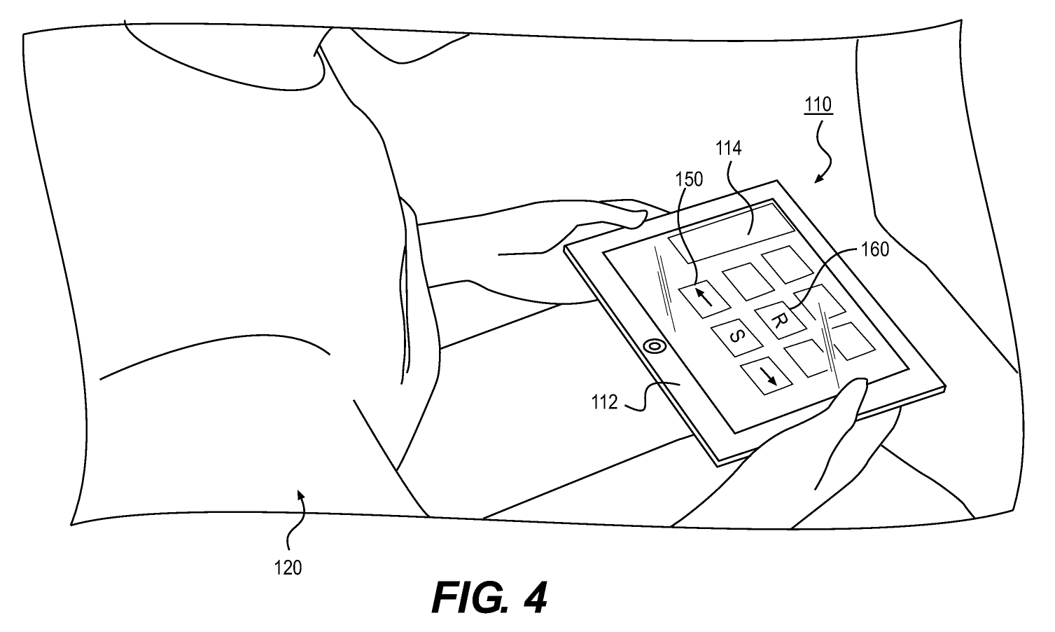

In FIG. 4, the device 110 may function similar to a Digital Video Recording (DVR) device. It has the ability to download or streaming data via the internet the remote record media (e.g. TV shows) at a set date and time from the home cable system (e.g. networked set-of-box 200 and smart or networked television set 210). The user can press the “R” key 160 for recording. Other keys are used for setting specific date and time. The user also can playback the media files with “S” Start Key, backward [<-] key, forward [->] key 150.

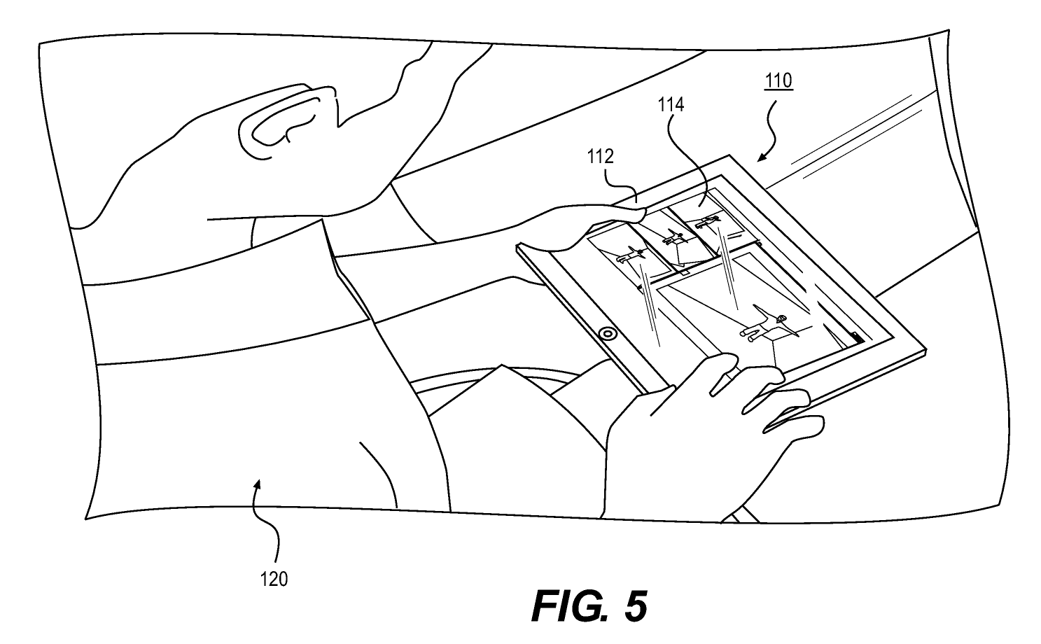

In FIG. 5, the user 120 can play downloaded or online games on the touch screen 114 of the device 110.

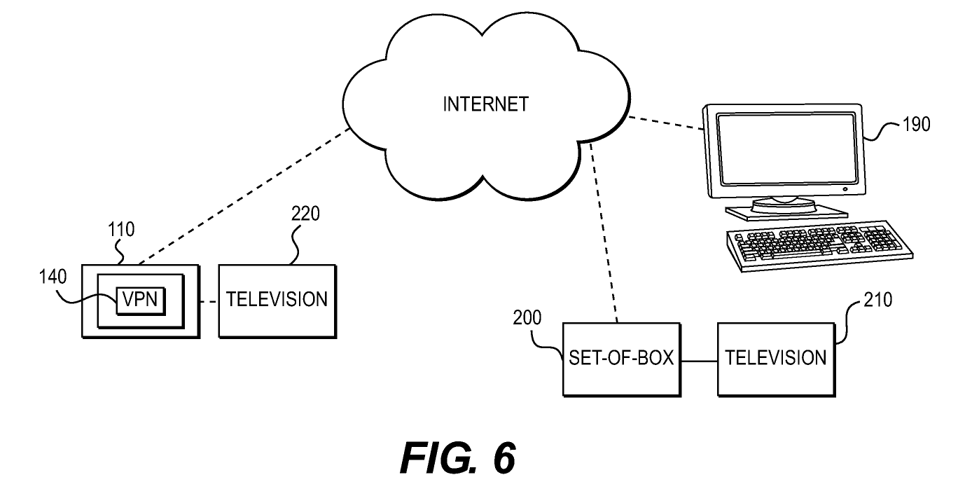

In FIG. 6, the device 110 may be taken anywhere and the customized media collection may be accessed at all times via local hard drive 122 and via a mobile Virtual Private Network (VPN) 140. It can be viewed directly on the touch screen 114 or may be connected to a smart or networked television set 220, stereo, or computer for viewing. The device 110 can also have a HDMI port (not shown) for outputting data to the television 220. A network 3D blue-ray disc player can be used with the television set 220 to make the television set 220 as a smart or networked television set 220.

In general, the device 110 may allow the user 120 to organize their media files in a variety of ways, such as by category, genre, or by favorites. The exact specifications may vary.

It will be understood that each of the elements described above, or two or more together, may also find a useful application in other types of constructions differing from the types described above.

While the invention has been illustrated and described as embodiments of a portable media device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A portable media player device which comprises:
a) a housing;
b) a touch screen mounted on the housing;
c) a built-in local hard drive for storing local movie, video, photo, music and game files within the housing;
d) a memory unit within the housing that processes the local movie, video, photo, music and game files therein;
e) a Wi-Fi network within the housing connected to the built-in hard drive to allow a user to directly download additional movie, video, photo, music and game files from internet;
f) a built-in mobile Virtual Private Network with a wireless receiver within the housing to allow the user to directly transport customized media files stored in a remote computer or a remote networked set-of-box to a virtual hard-drive on the device therein, and
g) a processing unit within the housing adapted to execute files stored in the built-in hard drive and display the files on the touch screen, whereby a user using the portable media player device can utilize the files by touching specific keys on the touch screen.

2. The device as recited in claim 1, further comprises an “R” key and other keys for remotely recording a specific television show via the remote networked set-of-box and a networked television set at a specific date and time.

3. The device as recited in claim 1, further comprises “S” Start key, backward [<-] key, forward [->] key for playback the media files therein.

4. The device as recited in claim 1, further comprises soft keys for allowing the user to organize the media files by category, genre, and favorites.

5. The device as recited in claim 1, further comprising a DVD/CD player/burner within the housing, whereby additional movie and music files may be loaded onto the hard drive.

6. The device as recited in claim 1, further comprising a USB port on the housing for additional file storage.

7. The device as recited in claim 1, further comprising a SD port on the housing for additional file storage.

8. The device as recited in claim 1, further comprising at least one speaker in the housing.

9. The device as recited in claim 1, further comprising a camera in the housing.

10. The device as recited in claim 1, further comprising a remote control unit.
